(19) United States
(12) Patent Application Publication
(10) Pub. No.: US 2026/0309520 A1
(43) Pub. Date: Oct. 8, 2026

(54) ANALYTICAL DEVICE AND OPTICAL FIBER SENSING METHOD

(71) Applicant: NIPPON TELEGRAPH AND TELEPHONE CORPORATION, Tokyo (JP)

(72) Inventors: Tatsuya OKAMOTO, Musashino-shi, Tokyo (JP); Daisuke IIDA, Musashino-shi, Tokyo (JP); Yusuke KOSHIKIYA, Musashino-shi, Tokyo (JP)

(73) Assignee: NTT, INC., Chiyoda-ku (JP)

(21) Appl. No.: 18/998,327

(22) PCT Filed: Aug. 3, 2022
(86) PCT No.: PCT/JP2022/029795

§ 371 Date: Jan. 24, 2025

(51) Int. Cl. G01D 5/353

(52) U.S. Cl. CPC G01D 5/35354

(57) ABSTRACT

An object of the present invention is to provide an analysis device of an optical fiber sensing device and an optical fiber sensing method which are capable of controlling the influence of a positional deviation, caused by vibration, with a small processing load without deteriorating a spatial resolution. An analysis circuit 12 measures a spectral shift Δν (xᵢ, t) for each section #i of an optical fiber 13 by using a measurement device 11 (steps S01, S02, Si1, and Si2), calculates an optical frequency modulation amount f(xᵢ, t) for each section from the spectral shift, accumulates the optical frequency modulation amount of the section positioned closer to a near end side than an analysis position of the optical fiber 13 to calculate a cumulative value f_{offset}(t) (step S03, step Si3), and corrects the analysis position xᵢ based on the cumulative value (step Sa1).

### TECHNICAL FIELD

The present disclosure relates to an analysis device of an optical fiber sensing device using optical frequency domain reflectometry (OFDR) and a sensing method thereof.

### BACKGROUND ART

FIG. 1 is a diagram for describing a sensing principle using OFDR. The OFDR adopts frequency sweep light as probe light. Further, a spectrum S(ν) (FIG. 1(B)) can be analyzed by performing Fourier-transform of a waveform r(τ) (FIG. 1(A)) of Rayleigh backscattered light related to probe light in an optical fiber (for example, see NPL 1).

The spectrum S(ν) of the backscattered light fluctuates (spectral shift) with respect to a strain and a temperature of the optical fiber. For this reason, by finding how much a reference spectrum S_{ref} obtained in reference measurement has moved at each measurement (spectral shift Δν), a strain of the optical fiber and the amount of change in temperature can be calculated as in the following formula.

$$\begin{matrix}[ Math . 0 ] & \\ - \frac{Δ v}{{v}_{0}} = 0.78 ε + 6.92 \times {10}^{- 6} T & ( 0 )\end{matrix}$$

Here, Δν is the spectral shift, ν₀ is a center frequency of the probe light, ε is the strain, and T is the temperature.

### CITATION LIST

### Non Patent Literature

[NPL 1] M. Froggatt and J. Moore, “High-spatial-resolution distributed strain measurement in optical fiber with Rayleigh scatter,” Appl. Opt., vol. 37, No. 10, pp. 1735-1740, 1998.
[NPL 2] Okamoto, Tatsuya, Daisuke Iida, and Hiroyuki Oshida. “Vibration-induced beat frequency offset compensation in distributed acoustic sensing based on optical frequency domain reflectometry”. Journal of Lightwave Technology 37.18 (2019): 4896-4901.
[NPL 3] Okamoto, Tatsuya, Daisuke Iida, and Hiroyuki Oshida. “Investigation of tolerance of OFDR-based DAS to vibration-induced beat frequency offset”., 2020 Optical Fiber Communications Conference and Exhibition (OFC). IEEE, 2020.

### SUMMARY OF INVENTION

### Technical Problem

An optical fiber sensing device using OFDR has a basic problem of difficulties in obtaining a consistent optical spectrum and performing correct vibration analysis, on the ground that optical frequency modulation, caused by vibration before an analysis position to be analyzed, varies distance of the analysis position.

FIG. 2 is a diagram for describing a basic problem. FIG. 2(A) shows a waveform r(τ) of Rayleigh backscattered light with respect to probe light of an optical fiber. In general, vibration is generated in an optical fiber. For this reason, the position of a waveform r(τ) needed to be analyzed fluctuates temporally due to vibration (frequency offset 21) of an optical fiber before an analysis position (time interval between τ₁ and τ₂) (probe light incident end side), and a waveform r(τ) ineligible for analysis is involved during the time interval between τ₁ and τ₂. That is, since waveforms r(τ) analyzed at the respective times varies, optical spectrum structures of waveforms of spectra S(ν) obtained by Fourier-transform of the waveforms r(τ) also varies, and calculating the amounts of spectral shift (strain amount) is difficult (FIG. 2(B)).

For this basic problem, NPL 2 discloses a method of alleviating the influence of a positional deviation due to expansion of an analysis length. This method uses the fact that, when the sensor length (time interval of τ₁ to τ₂) is sufficiently longer than the frequency offset 21, a positional deviation can be suppressed (having proof stress against vibration). However, this method has a new problem that a spatial resolution of strain analysis deteriorates when the length of analysis is increased.

In addition, for this basic problem, NPL 3 discloses a method of correcting a positional deviation by signal processing. This method is signal processing for estimating a distance offset by cross-correlation of loss distribution waveforms of a vibration sensor and tracking the position of the vibration sensor to be analyzed. However, this method has a new problem that a signal load for cross-correlation is large.

Consequently, in order to solve the above-described problems, an object of the present invention is to provide an analysis device of an optical fiber sensing device and an optical fiber sensing method which are capable of controlling the influence of a positional deviation, caused by vibration, with a small processing load without deteriorating a spatial resolution.

### Solution to Problem

In order to achieve the above-described object, an optical fiber sensing device and a method thereof according to the present invention are designed for obtaining an optical frequency modulation amount at each section of an optical fiber from a spectral shift at each section of the optical fiber, and correcting a positional deviation of an analysis position by using a cumulative value of the optical frequency modulation amounts at individual sections positioned before the analysis position.

Specifically, an analysis device of an optical fiber sensing device according to the present invention is an analysis device included in an optical fiber sensing device using OFDR, the analysis device
calculating an optical frequency modulation amount for each section of an optical fiber from a spectral shift measured for each section of the optical fiber,
accumulating the optical frequency modulation amount of the section positioned closer to a near end side than an analysis position of the optical fiber to calculate a cumulative value, and
correcting the analysis position based on the cumulative value.

In addition, an optical fiber sensing method according to the present invention is an optical fiber sensing method using OFDR, the optical fiber sensing method including
measuring a spectral shift for each section of an optical fiber,
calculating an optical frequency modulation amount for each section from the spectral shift,
accumulating the optical frequency modulation amount of the section positioned closer to a near end side than an analysis position of the optical fiber to calculate a cumulative value, and
correcting the analysis position based on the cumulative value.

The optical fiber sensing device measures an optical frequency modulation amount by dividing an optical fiber into a plurality of sections on the assumption that cumulative amount of strain at respective sections is the amount of expansion and contraction of the optical fiber caused by vibration, and corrects a positional deviation of the analysis position using the cumulative value of the optical frequency modulation amount at each section positioned before the analysis position. For this reason, the present invention can provide an analysis device of an optical fiber sensing device and an optical fiber sensing method which are capable of controlling the influence of a positional deviation, caused by vibration, with a small processing load without deteriorating a spatial resolution.

The calculating of the cumulative value may be accumulating the optical frequency modulation amount from the section at the near end to the section immediately before the analysis position, or accumulating the optical frequency modulation amount from any of the sections to the section immediately before the analysis position.

The present invention is a program that causes a computer to function as the analysis device.

The analysis device can also be implemented by a computer and a program, and the program can be recorded in a recording medium or provided through a network.

The above inventions can be combined whenever possible.

### Advantageous Effects of Invention

The present invention can provide an analysis device of an optical fiber sensing device and an optical fiber sensing method which are capable of controlling the influence of a positional deviation, caused by vibration, with a small processing load without deteriorating a spatial resolution.

### BRIEF DESCRIPTION OF DRAWINGS

FIG. 1 is a diagram for describing a sensing principle using OFDR.

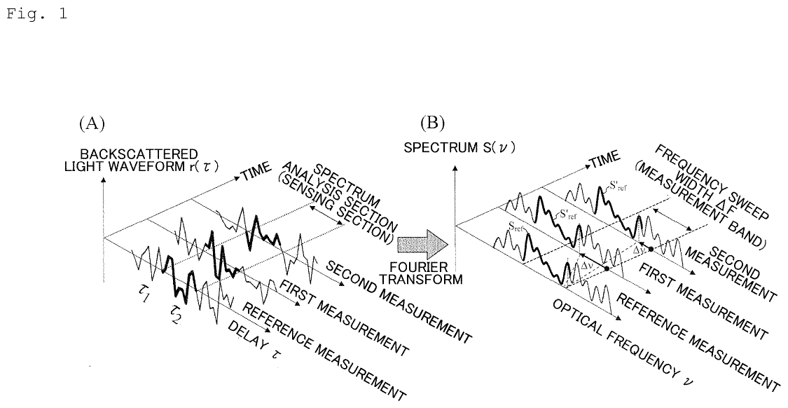

FIG. 2 is a diagram for describing problems of the present invention.

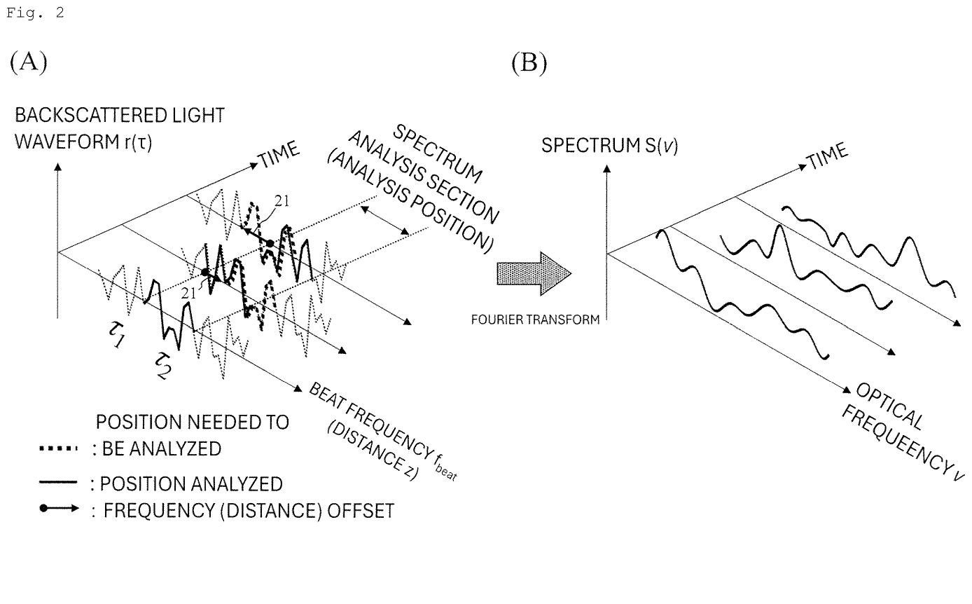

FIG. 3 is a diagram for describing an optical fiber sensing device according to the present invention.

FIG. 4 is a diagram for describing an optical fiber sensing method according to the present invention.

FIG. 5 is a diagram for describing the principle of the optical fiber sensing method according to the present invention.

FIG. 6 is a diagram for describing effects of the optical fiber sensing method according to the present invention.

FIG. 7 is a diagram for describing the optical fiber sensing device according to the present invention.

FIG. 8 is a diagram for describing effects of the optical fiber sensing method according to the present invention.

FIG. 9 is a diagram for describing an optical fiber sensing device according to the present invention.

### DESCRIPTION OF EMBODIMENTS

Embodiments of the present invention will be described with reference to the accompanying drawings. The embodiments to be described below are examples of the present invention, and the present invention is not limited to the following embodiments. It is assumed that constituent elements with the same reference numerals in the present specification and the drawings represent the same constituent elements.

### First Embodiment

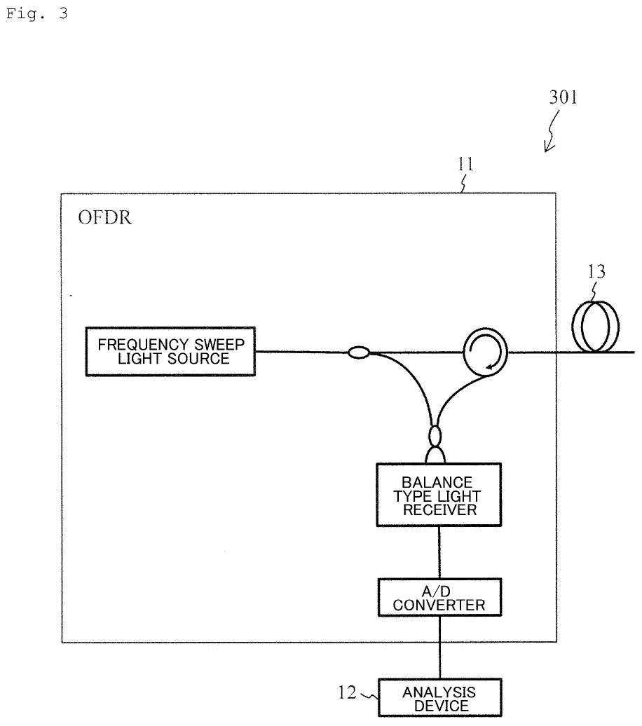

FIG. 3 is a diagram for describing an optical fiber sensing device 301 according to the present embodiment. The optical fiber sensing device 301 is a sensing system that includes a measurement device 11 and an analysis device 12. The measurement device 11 is an OFDR device for inputting probe light whose frequency is swept once to an optical fiber 13 and acquiring a spectrum of Rayleigh backscattered light in the optical fiber 13.

In the present specification, one of both ends of the optical fiber 13 which is connected to the measurement device 11 may be referred to as a “near end” and the other end thereof may be referred to as a “far end”.

The analysis device 12 acquires a spectral shift Δν from a time variation of the spectrum obtained by the measurement device 11. Then, the analysis device 12 partitions the optical fiber 13 into a plurality of sections #i (“i” is a section number and is selected out of integers from 0 to N) in the longitudinal direction, obtains an optical frequency modulation amount f(xᵢ, t) at each of the sections from a spectral shift Δν(xᵢ, t) at each of the sections of the optical fiber 13, and corrects a positional deviation of an analysis position by using a cumulative value f_{offset}(t) of the optical frequency modulation amounts at individual sections positioned before the analysis position.

The positional deviation correction of the analysis position which is performed by the analysis device 12 will be described below in detail.

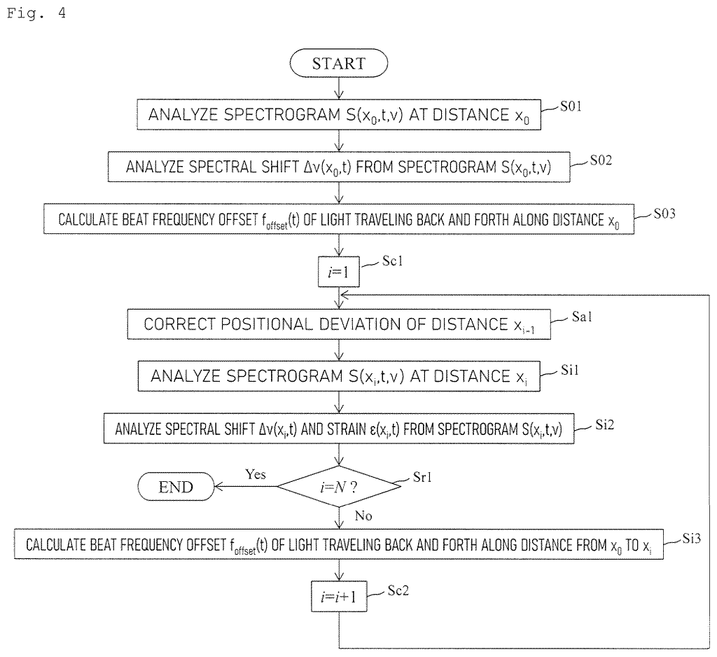

FIG. 4 is a flowchart for describing an optical fiber sensing method performed by the analysis device 12.

### The Analysis Device 12

measures a spectral shift Δν (xᵢ, t) for each section #i of the optical fiber 13 by using the measurement device 11 (steps S01, S02, Si1, Si2),
calculates an optical frequency modulation amount f(xᵢ, t) for each section from the spectral shift,
accumulates the optical frequency modulation amount of the section positioned closer to the near end side than the analysis position of the optical fiber 13 to calculate a cumulative value f_{offset}(t) (step S03, step Si3), and
corrects the analysis position xᵢ based on the cumulative value (step Sa1).

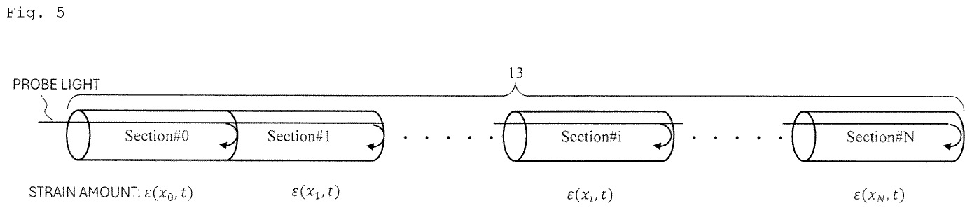

FIG. 5 is an image diagram for describing the correction of a positional deviation of an analysis position in this optical fiber sensing method. The optical fiber 13 is divided into a plurality of sections #i (i is selected out of integers from 0 to N) and performs examination. xᵢ represents the length of the section #i, t represents the time, and ε(xᵢ, t) represents a strain amount of the optical fiber 13 in the section #i. The length xᵢ is set to be longer than a spatial resolution L of a strain that can be detected by the measurement device 11.

This optical fiber sensing method adopts analyzing an optical frequency modulation amount f(xᵢ, t) from a strain amount ε(xᵢ, t) at each section #i, and obtaining an optical frequency modulation amount of probe light propagated from the near end to the section #i by the accumulation of the optical frequency modulation amounts from a section #0 to the section #i. In this optical fiber sensing method, the strain amount ε is expressed by a spectral shift Δν(xᵢ, t).

### [Step S01]

The analysis device 12 acquires a spectrogram S(x₀, t, ν) from return light from the section #0 (a position where a distance from the near end is x₀) in the backscattered light acquired by the measurement device 11. ν is an optical frequency.

### [Step S02]

Then, the analysis device 12 analyzes a spectral shift Δν(x₀, t) from the spectrogram S(x₀, t, ν). A method of analyzing the spectral shift Δν from the spectrogram S may be a method disclosed in NPL 1.

### [Step S03]

The analysis device 12 calculates an optical frequency modulation amount f(x₀, t) from Δν(x₀, t) by the following formula. A relationship between the strain amount ε and a phase change amount θ will be described with reference to Appendix A.

$$[ Math . 1 ]$$

$$Phase change amount :$$

$$θ ( {x}_{0} , t ) = \frac{2 π nL}{0.78 c} Δ v ( {x}_{0} , t ) \qquad ( 1 )$$

$$Optical frequency modulation amount :$$

$$f ( {x}_{0} , t ) = \frac{1}{2 π} \frac{d}{dt} θ ( {x}_{0} , t )$$

Further, the analysis device 12 calculates a beat frequency offset f_{offset}(t) of probe light traveling back and forth along the section #0 (distance x₀).

$$[ Math . 2 ]$$

$${f}_{offset} ( t ) = 2 {\int }_{{x}_{i}}^{{x}_{j}} f ( x , t ) dx \qquad ( 2 )$$

Since Formula (2) depicts a frequency modulation amount of probe light traveling along a distance from xᵢ to xⱼ, a frequency offset at the section #0 is f_{offset}(t)=2f(x₀, t).

### [Step Sc1]

Section numbers are set to 0 to 1.

### [Step Sa1]

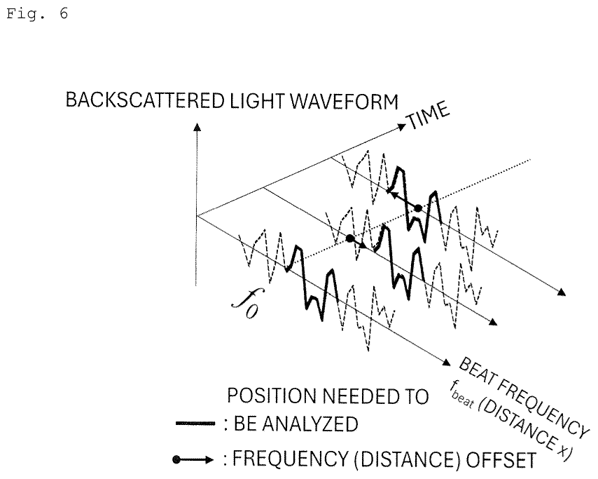

FIG. 6 is a diagram for describing step Sa1. The analysis device 12 corrects a positional deviation of a vibration analysis position (distance xᵢ₋₁; distance x₀ after step S03, and distance xᵢ₋₁ after the step Si3) by the following formula.

$$[ Math . 3 ]$$

$$Given notation with bit frequency :$$

$${f}_{0} + {f}_{offset} ( t ) \qquad ( 3 )$$

$$Given notation with distance :$$

$$\frac{c}{2 n γ} \times ( {f}_{0} + {f}_{offset} ( t ) )$$

That is, the analysis device 12 corrects the positional deviation of the vibration analysis position by using an accumulated f_{offset}(t) of the optical frequency modulation amount from the section #0 to a section #i−1.

### [Step Si1]

The analysis device 12 acquires a spectrogram S(xᵢ, t, ν) from return light from the section #i (a position where a distance from the near end is xᵢ) in the backscattered light acquired by the measurement device 11. ν is an optical frequency.

### [Step Si2]

Then, the analysis device 12 analyzes a spectral shift Δν(xᵢ, t) from the spectrogram ε(xᵢ, t, ν).

Here, the analysis device 12 may calculate a strain amount ε(xᵢ, t) for each section from the spectral shift Δν(xᵢ, t) for each section #i. The strain amount ε(xᵢ, t) may be calculated only for a desired analysis position. Specifically, the strain amount ε(xᵢ, t) is calculated using Formula (A2) described in Appendix A at a position xᵢ where a positional deviation is corrected.

### [Step Si3]

A beat frequency offset f_{offset}(t) of light traveling back and forth along the distance from x₀ to xᵢ is calculated using Formula (2).

When i=N, this step is not performed, and the processing is terminated.

After step Si3, the section number is counted up by one in step Sc2 to cause the processing to return to step Sa1, and a positional deviation of a vibration analysis position (distance xᵢ₋₁) is corrected by Formula (3).

### Examples

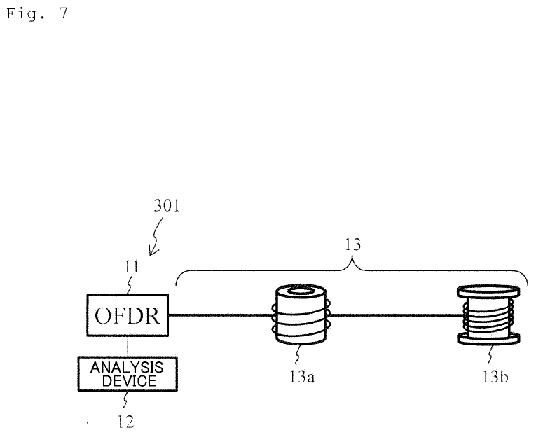

FIG. 7 is a diagram for describing an experimental system. The optical fiber 13 is divided into two sections, that is, an optical fiber 13a on the near end side and an optical fiber 13b on the far end side. The length of the optical fiber 13a is 60 m, and the length of the optical fiber 13b is 160 m. A sinusoidal vibration of 30 Hz is applied only to the optical fiber 13a.

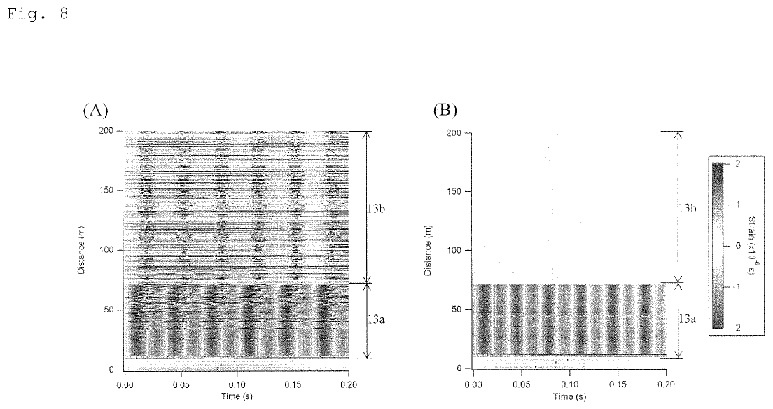

A spatial resolution L of the measurement device 11 is 66 cm. FIG. 8 is a diagram for describing effects of the present invention. FIG. 8(A) shows results (comparative example) of strain measurement in which the analysis device 12 does not correct a positional deviation in the experimental system shown in FIG. 7. FIG. 8(B) shows results (example) of strain measurement in which the analysis device 12 corrects a positional deviation in the experimental system shown in FIG. 7.

In the comparative example, a strain ε can be measured correctly up to a distance of approximately 0 m to 30 m, but a measurement error occurs at the subsequent distances. This means the following. The spatial resolution of the measurement device 11 has proof stress against an accumulated frequency modulation amount when a distance in which probe light travels is in a range from 0 m to approximately 30 m, but the spatial resolution has insufficient proof stress against the accumulated frequency modulation amount when the distance is out of the range. In particular, a measurement error frequently occurs near the time when a positional deviation is maximized or near the time when a strain having a sine wave shape becomes zero.

On the other hand, in the example, a positional deviation is corrected in both the section of the optical fiber 13a and the section of the optical fiber 13b to which no vibration is applied, and a strain ε is correctly measured.

### (Supplementary Notes)

As shown in Formula (A3), a strain ε gives a phase change θ to probe light. A time differential of the phase change θ is an optical frequency modulation amount f. In this experiment, a strain having a sine wave shape is added, and thus the optical frequency modulation amount (positional deviation amount) is maximized at the time when a strain becomes zero (a time differential of a sine wave is maximized when the time differential of the sine wave passes through a zero point). The experimental results certainly show the situation, and a measurement error occurs near the time when a strain becomes zero.

The optical frequency modulation amount f due to the strain E is accumulated with the propagation of the probe light. For this reason, the strain ε can be measured correctly up to a distance of approximately 0 m to 30 m, but a cumulative value of an optical frequency modulation amount exceeds the spatial resolution of the measurement device 11 at the subsequent distances, which results in a measurement error.

### (End of Supplementary Notes)

### Effects

In the optical fiber sensing method according to the present invention, as described with reference to FIG. 8, a load (differentiation and addition) of signal processing is smaller than that in the related method (cross-correlation), and a vibration distribution can be measured without deteriorating a spatial resolution of strain analysis.

In the above-described embodiment, optical frequency modulation amounts f(xᵢ, t) from a section #0, beside a near end, to a section #N−1 immediately before an analysis position are accumulated, and position correction is performed. In the optical fiber sensing method according to the present invention, as described in Formula (2), a frequency offset f_{offset}(t) at any section (xᵢ to xⱼ) can be calculated. For this reason, a positional deviation amount can also be analyzed by accumulating an optical frequency modulation amount f(xᵢ, t) not only from a section at the near end but also from a section at an arbitrary point to the section #N−1 immediately before the analysis position. Thus, the optical fiber sensing method according to the present invention can improve both the accuracy of strain measurement and convenience.

### Second Embodiment

The analysis device 12 can also be implemented by a computer and a program, and the program can be recorded in a recording medium or provided through a network.

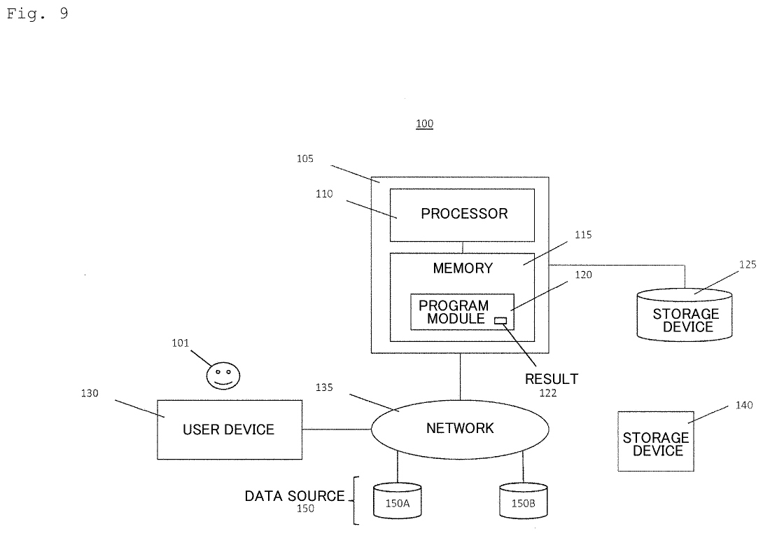

FIG. 9 shows a block diagram of a system 100. The system 100 includes a computer 105 connected to a network 135.

The network 135 is a data communication network. The network 135 may be a private network or a public network, and can include any or all of (a) a personal area network covering, for example, a certain room; (b) a local area network covering, for example, a certain building; (c) a campus area network covering, for example, a campus, (d) a metropolitan area network, covering a certain city; (e) a wide area network covering, for example, an area spanning over boundaries of cities, regions, or countries, and (f) the Internet. Communication is performed using electronic signals and optical signals via the network 135.

The computer 105 includes a processor 110 and a memory 115 connected to the processor 110. Although the computer 105 is described herein as a standalone device, the computer is not limited thereto, and the computer may be connected to other device (which is not illustrated) in the distributed processing system.

The processor 110 is an electronic device including a logic circuit which responds to and executes instructions.

The memory 115 is a tangible computer-readable storage medium on which a computer program is encoded. In this regard, the memory 115 stores data and instructions, or program codes which are readable and executable by the processor 110 to control the operation of the processor 110. The memory 115 may be realized as a random access memory (RAM), a hard drive, read only memory (ROM), or a combination thereof. One of components of the memory 115 is a program module 120.

The program module 120 includes an instruction for controlling the processor 110 to perform the process described herein. This specification describes operations executed by the computer 105 or a method or process or sub-processes thereof, but these operations are actually executed by the processor 110.

The term “module” is used herein to refer to functional operation which may be embodied either as a stand-alone component or an integrated configuration including a plurality of subordinate components. Thus, the program module 120 can be realized as a single module or as a plurality of modules which operate in cooperation with one another. Further, although this specification describes the program module 120 installed in the memory 115 and thus implemented in software, the program module 120 may be implemented in any of hardware (for example, an electronic circuit), firmware, software, or a combination thereof.

The program module 120 is illustrated as already being loaded in the memory 115 but may be configured to be located on the storage device 140 for later loading into the memory 115. The storage device 140 is a tangible, computer-readable storage medium which stores the program module 120. Examples of the storage device 140 include a compact disk, a magnetic tape, a read only memory, an optical storage medium, a memory unit configured of a hard drive or a plurality of parallel hard drives, and a universal serial bus (USB) flash drive. Alternatively, the storage device 140 may be a random access memory or another type of electronic storage device that is located in a remote storage system (not illustrated) and connected to the computer 105 via the network 135.

The system 100 further includes a data source 150A and a data source 150B collectively referred to as data sources 150 in this specification and communicatively connected to the network 135. In practice, the data source 150 may include any number of data sources, that is, one or more data sources. The data source 150 can include non-systemized data and can include social media.

The system 100 further includes a user device 130 which is operated by a user 101 and connected to the computer 105 via the network 135. The user device 130 can be an input device such as a keyboard or a voice recognition subsystem for allowing the user 101 to communicate information and command selection to the processor 110. The user device 130 further includes an output device such as a display device or printer or a speech synthesizer. A cursor control unit such as a mouse, a trackball, and a touch-sensitive screen allows the user 101 to manipulate the cursor on the display device to transmit further information and command selection to the processor 110.

The processor 110 outputs results 122 of the execution of the program module 120 to the user device 130. Alternatively, the processor 110 can bring the output to a storage device 125, such as a database or a memory, or to a remote device (which is not illustrated) via the network 135.

For example, the program which performs the flowchart in FIG. 4 can be the program module 120. The system 100 can be operated as the analysis device 12.

The term “comprises” or “comprising” specifies the presence of stated features, integers, steps, or elements, but should be understood as what does not exclude the presence of one or more other features, integers, steps, or elements or groups thereof. The terms “a” and “an” are indefinite articles and, thus, embodiments having a plurality of the terms are not excluded.

### Other Embodiments

The present invention is not limited to the above-described embodiments, and can be implemented with various modifications without departing from the gist of the present invention. In short, the present invention is not limited by the above-described embodiments as it is and can be embodied by modifying components without departing from the gist and scope of the invention in the application.

In addition, various inventions can be formed by appropriate combinations of the plurality of components disclosed in the above-described embodiments. For example, some components may be deleted from all components shown in the embodiments. Further, components across different embodiments may be combined as appropriate.

### [Appendix A]

A relationship among a strain amount ε, a spectral shift Δ, and a phase change amount θ will be described.

A strain and temperature dependence of a spectral shift of Rayleigh backscattered light are given by the following formula.

$$[ Math . A 1 ]$$

$$- \frac{Δ v}{{v}_{0}} = 0.78 ε + 6.92 \times {10}^{- 6} T \qquad ( A1 )$$

Considering a situation where there is no temperature change T and only a strain ε is applied to an optical fiber, a spectral shift Δν of the Rayleigh backscattered light is given by the following formula.

$$[ Math . A 2 ]$$

$$- \frac{Δ v}{{v}_{0}} = 0.78 ε \qquad ( A 2 )$$

When a section of a length L changes by the amount of expansion and contraction ΔL due to the strain ε, the phase change amount θ is given by the following formula.

$$[ Math . A 3 ]$$

$$\begin{matrix}θ ( {x}_{0} , t ) = kn Δ L \\ = kn ε L \\ = - \frac{knL}{0.78 {v}_{0}} Δ v ( {x}_{0} , t ) \\ = - \frac{2 π nL}{0.78 c} Δ v ( {x}_{0} , t )\end{matrix} \qquad ( A 3 )$$

### Definition

The parameters used in this specification are as follows. 1x: Position of optical fiber in longitudinal direction (distance from near end)
t: Time
n: Refractive index of optical fiber
Δν: spectral shift
ν₀: Central optical frequency of probe light
c: Velocity of light in vacuum
L: Spatial resolution of strain that can be detected by measurement device
k: Wave number
T: Change in temperature of optical fiber
f₀: Vibration analysis position when t=0
Y: Frequency sweep speed of OFDR (measurement device)

### REFERENCE SIGNS LIST

11 Measurement device
12 Analysis circuit
13 Optical fiber
100 System
101 User
105 Computer
110 Processor
115 Memory
120 Program module
122 Result
125 Storage device
130 User device
135 Network
140 Storage device
150 Data source
301 Optical fiber sensing device

1. An analysis device included in an optical fiber sensing device using OFDR, the analysis device
calculating an optical frequency modulation amount for each section of an optical fiber from a spectral shift measured for each section of the optical fiber,
accumulating the optical frequency modulation amount of the section positioned closer to a near end side than an analysis position of the optical fiber to calculate a cumulative value, and
correcting the analysis position based on the cumulative value.

2. The analysis device according to claim 1, wherein
the calculating of the cumulative value is accumulating the optical frequency modulation amount from the section at the near end to the section immediately before the analysis position.

3. The analysis device according to claim 1, wherein
the calculating of the cumulative value is accumulating the optical frequency modulation amount from any of the sections to the section immediately before the analysis position.

4. An optical fiber sensing method using OFDR, the optical fiber sensing method comprising:
measuring a spectral shift for each section of an optical fiber;
calculating an optical frequency modulation amount for each section from the spectral shift;
accumulating the optical frequency modulation amount of the section positioned closer to a near end side than an analysis position of the optical fiber to calculate a cumulative value; and
correcting the analysis position based on the cumulative value.

5. The optical fiber sensing method according to claim 4, wherein the calculating of the cumulative value is accumulating the optical frequency modulation amount from the section at the near end to the section immediately before the analysis position.

6. The optical fiber sensing method according to claim 4, wherein the calculating of the cumulative value is accumulating the optical frequency modulation amount from any of the sections to the section immediately before the analysis position.

7. A non-transitory computer-readable storage medium storing a program that causes a computer to function as the analysis device according to claim 1.
